(19) United States
(12) Patent Application Publication
(10) Pub. No.: US 2006/0108810 A1
(43) Pub. Date: May 25, 2006

(54) Combined rotor latch and hinge and car-top box carrier clamps

(75) Inventors: William D. Denison, Lake Zurich, IL (US); Gary L. Myers, Monee, IL (US); Richard Paeth, St. Charles, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, LLC, Elk Grove, IL (US)

(21) Appl. No.: 11/249,086

(22) Filed: Oct. 12, 2005

Related U.S. Application Data
(60) Provisional application No. 60/617,994, filed on Oct. 12, 2004.

(51) Int. Cl. E05C 3/06; E05C 3/02

(52) U.S. Cl. 292/194

(57) ABSTRACT

The present invention provides a latching device that can function as a hinge or a latch. A door incorporating this latching device can be operated as a left hand (front) or right hand (rear) opening device. The device can be used for car-top carriers, tool storage boxes, merchant displays, truck storage boxes, and other applications that need to open from two sides. The device can have multiple locking, latching, and hinging elements. The latches can be locked using conventional key-operated handles, cam locks, or electronically. The device features direct visual and audible user feedback to confirm proper latching and locking operation. When used for car-top box carriers that attach to automotive roof racks, the device can use an “L”-shaped clamp with a safety catch.

### CROSS REFERENCE TO RELATED APPLICATION

This application claims priority to U.S. Provisional Patent Application 60/617,994, filed on Oct. 12, 2004, which is incorporated herein by reference in its entirety.

### TECHNICAL FIELD

The present invention relates generally to latches for cabinet-type utility enclosures and, more particularly, to a rotor latch and strike interface control system.

### BACKGROUND OF THE INVENTION

Pin latches have been used to secure many types of utility enclosures including car-top carriers. The pin is used as a holding element for the latch as well as a pivot for the hinge.

A disadvantage of a mechanically controlled pin latch as described above is that often the pin needs to be retracted from a hinge element while under high loads. These loads cause excessive binding and may eventually lead to failure of the access-control device (usually a key).

Another disadvantage is that most pin devices cannot withstand conventional temperature variations. The pin requires a substantial co-linear area which causes it to bind when cold. Leaving the co-linear area loose is not an acceptable option because the tolerance leads to mechanical failure from vibration.

Another disadvantage of the pin latch is that it cannot provide a system that gives its user feedback that it is properly latched.

Also, because the forces needed to latch the device are often so high, the “rods” that connect the system together can fail. These failures can lead to serious accidents when this system is employed to latch a car-top carrier.

Existing devices in this field use clamping systems that require installation by several persons. These devices have removable parts that often must be held in position externally to allow the clamps to be installed internally.

### SUMMARY OF THE INVENTION

In view of the foregoing, the present invention improves on the methods, operations, and interfaces of latching and unlatching a hinge. The present invention makes it possible to remove certain components from the outside of an enclosure door. This improvement enhances security by providing a more difficult point of attack. It also provides additional exterior surface area on which to add decorative features to the enclosure door.

In one embodiment, this invention provides a combination of rotor latches to enhance the latching of an enclosure. In a mechanism consisting of more than one rotor latch, a common unlatching system connects to each latch to simultaneously unlatch all of the latches. The common unlatching system can be mechanical, such as a rod or a pin to control the rotor. It can be either electronically controlled by a solenoid or actuator or mechanically controlled by a quarter-turn cam lock or other mechanical actuator.

In one embodiment, the present invention provides a mechanical indicator that can be seen from outside the enclosure to indicate the status of the latch position (or the status of the positions of the multiple latches if so provided).

In one embodiment, the present invention includes a roller over the strike or pin to reduce the friction of the mechanical interface between the rotor and the pin or strike.

In one embodiment, an enclosure has a plurality of rotor latches and pins or strikes at opposite sides of the enclosure to allow the enclosure to be opened from either side. In this embodiment, at least two rotor latches on the near side of the enclosure are used to access the enclosure, and at least two latches on the far side of the enclosure act as a hinge of the enclosure when the enclosure is opened from the near side, and vice versa. In this embodiment, one or more of the rotor latches are configured to act as a common hinge axis.

This invention is not limited to any particular type, style, or application of enclosure. In addition, although the preferred embodiment of the invention includes a door with single rotor latch interfacing to a single pin or strike in the cabinet of the enclosure, this invention also supports the opposite arrangement such as a rotor latch in a cabinet that interfaces into a pin or strike in the door frame, as well as many other types of door, cabinet, and mechanism arrangements as are available.

In one embodiment, the clamp system is a lever-operated cam, over-center design that uses an “L”-formed grooved wire to hold a luggage or ski-type box onto a automotive roof rack.

The first object of the invention is to improve the locking and unlocking operation of an enclosure interfaced to an improved rotor latch and pin or strike mechanism.

The second object is to replace the manual access control of the rotor with an electronic access control.

The third object is to provide a faster method for accessing and locking the enclosure.

The fourth object is to provide an enclosure that can be reliably accessed from either end of the enclosure.

The fifth object is to provide a more user-friendly electronically controlled device to access and lock the door.

The sixth object is to provide a device that is battery powered, although the invention is not limited to battery-controlled operation.

The seventh object is to provide a rotor latch that when latched can operate as a common hinge.

The eighth object is to provide an improved rotor latch that can be effectively unlatched while a load force is applied to an opposite member of the rotor latch.

The ninth object is to provide an improved rotor-latch system that indicates to a user whether proper engagement and latching has occurred.

The tenth object is to provide a single-point access control for single- or multiple-point latches.

The eleventh object is to provide a latch system that supports many types of locking-control devices such as keys, handles, and electronics.

The twelfth object is to provide a structure for mounting the latches and for adding support to an enclosure.

The thirteenth object is to provide a user with audible feedback of the latching function.

The fourteenth object is to provide a user with a method to overcome any malfunctions of the mechanism using the locking-control devices.

The fifteenth object is to provide a latching device that withstands common temperature variations without a degradation of operation.

The sixteenth object is to provide a clamping system that installs and clamps tight from inside an enclosure.

The seventeenth object is to provide an “L”-shaped wire to the clamp.

The eighteenth object is to provide a safety device to the clamp to prevent accidental lifting of the clamping handle.

The nineteenth object is to provide a safety device that keeps the clamp and box on the car-top carrier when the clamps are not tightened.

### BRIEF DESCRIPTION OF THE DRAWINGS

While the appended claim sets forth features of the present invention, the invention, together with its objects and advantages, may be best understood from the following detailed description taken in conjunction with the accompanying drawings of which:

FIG. 1 is a perspective view of a rotor-latch mechanism with two rotor latches according to an embodiment of the present invention;

FIG. 2 is a close-up perspective view of one of the two rotor-latches of FIG. 1;

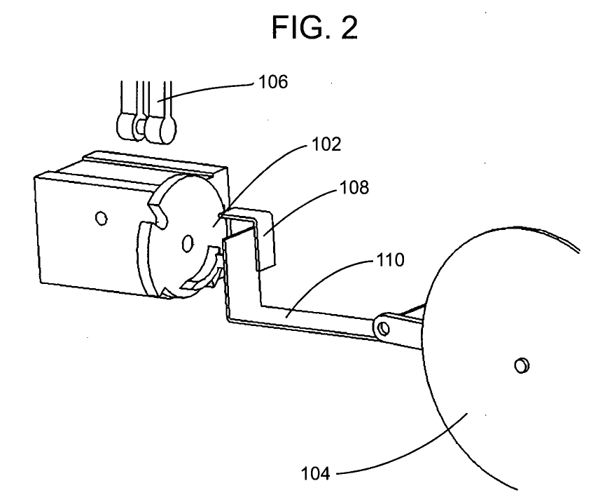

FIG. 3 is a perspective view of the rotor-latch mechanism of FIG. 1 in an unlatched position;

FIG. 4 is a perspective view of a rotor-latch in a latched position; and

FIG. 5 is a perspective view of the rotor-latch mechanism of FIG. 1 in a latched position.

### DETAILED DESCRIPTION OF THE INVENTION

The following description is based on illustrative embodiments of the invention and should not be taken as limiting the invention to alternative embodiments that are not explicitly described herein.

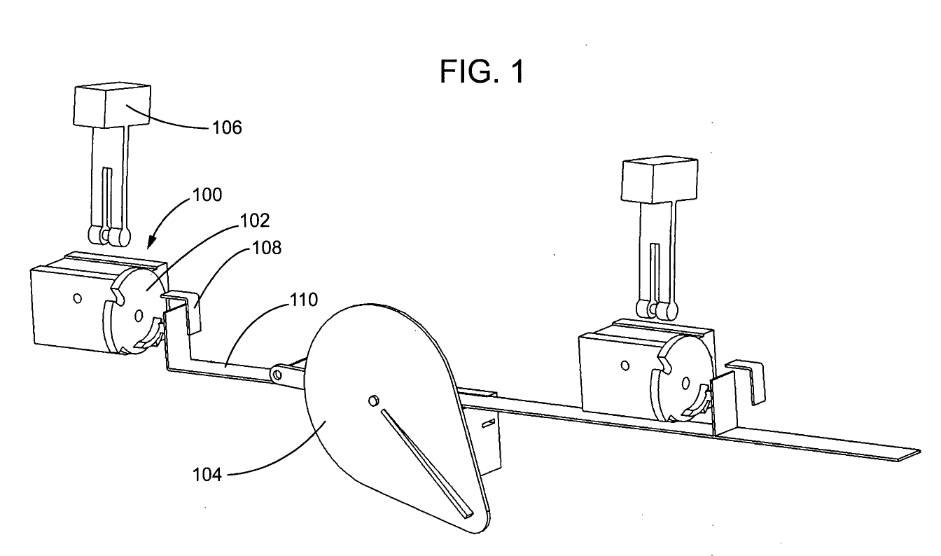

Turning to the drawings, FIG. 1 shows a first embodiment of the present rotor latch 100 including a rotor 102 and a latch-release mechanism which is mechanically or electrically locked. If the rotor latch 100 is mechanically locked, then it includes a lock core or a handle 104 with a lock core. If the rotor latch 100 is electronically locked, then it includes an electronic control interface added to a mechanical release mechanism, an access control device, and a power source.

The rotor latch 100 is mounted inside of a housing that serves to support a rotor pivot shaft, as well as providing a structure for controlling the strike 106. Control surfaces allow the strike 106 to rotate while keeping the strike 106 confined, thereby preventing the member to which the strike 106 is attached from becoming dislodged. The housing is further mounted to a co-linear support frame that spatially aligns and reinforces one, two, or more rotor latches 100 to fit specific enclosure designs. The housing also has surfaces that align the strikes 106 as they begin to engage.

The rotor 102 pivots about an axis parallel to a door's hinge axis. The rotor latch 100 is constructed from high-strength materials such as steel or brass. The rotor latch 100 has two states of operation: latched (strike 106 engaged) and unlatched (strike 106 not engaged). The rotor latch 100 can be spring- or gravity-biased to its unlatched position, but that is not required for operation. Motion of the rotor 102 is governed by the strike 106 moving in and out of contact with it. The force required to generate motion to the strike 106 comes from direct input from a user, either by pulling the strike 106 out of engagement or by pushing it into engagement. This operation is similar to that of a common automobile door lock.

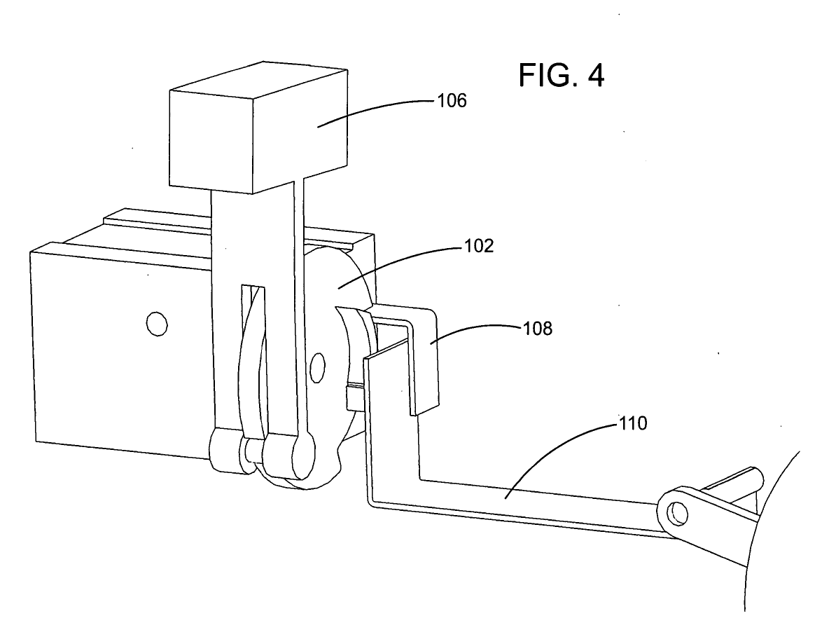

As shown in FIG. 4, the rotor 102 is prevented from rotating when latched by a spring-biased, linear motion, physical blocking device 108. This device 108 moves perpendicularly to the rotor pivot shaft. The interface to the rotor 102 when latched is relatively small. A physical blocking device indicator (a key or handle 104) can easily overcome the friction from this small cross section. By requiring the use of a small section, the motion of the blocking device 108 is not critical to proper operation. The blocking device 108 can have a substantial over-travel motion without negative impact. This device 108 is co-linear when used with multiple axially aligned latching devices 100.

The physical blocking device 108 interfaces with the rotor 102 so as to prevent the rotor 102 from returning to its latched position until the rotor 102 has a strike 106 inside its physical opening and is rotated to the proper latched position.

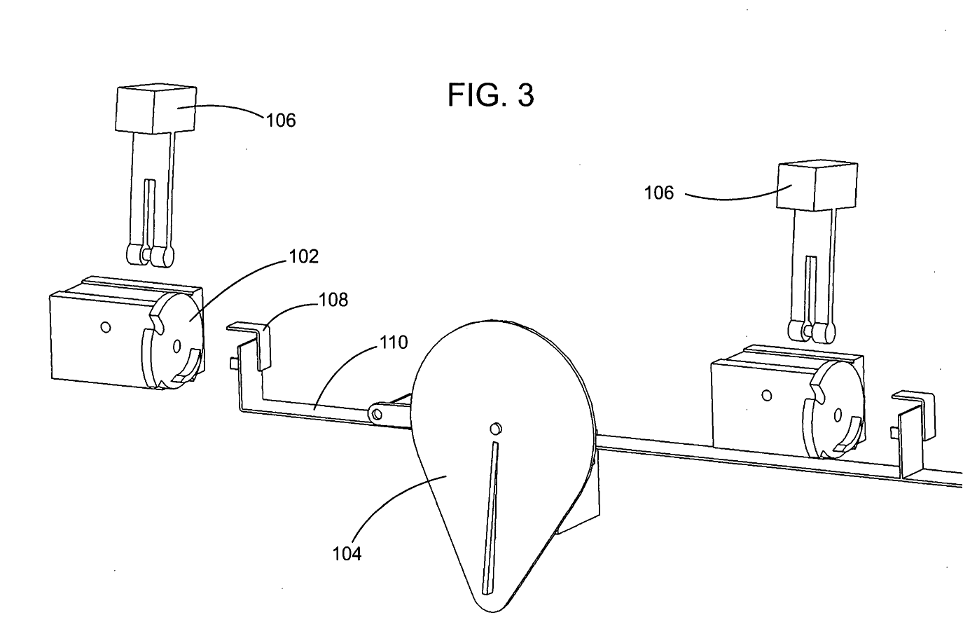

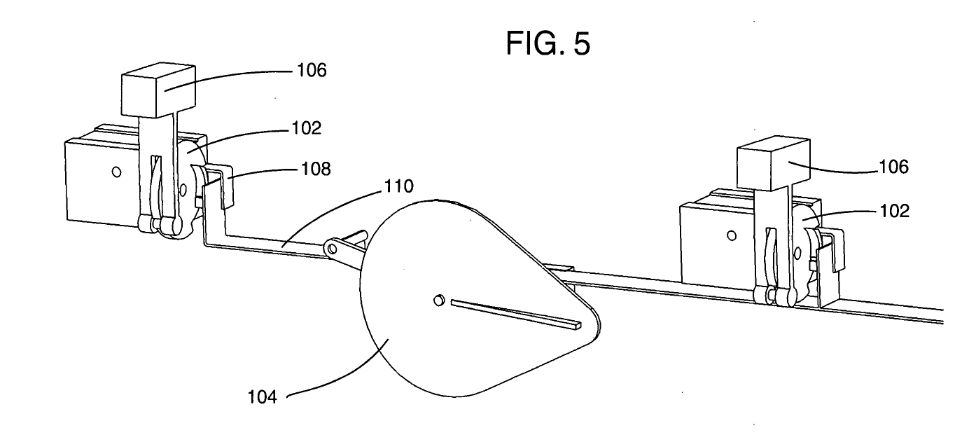

A key or handle 104 serves as the indicator. The indicator handle 104 is attached physically to the blocking device 108. The indicator handle 104 is a crankshaft-type device that translates the linear motion of the spring-biased physical blocking device 108 via a connecting bar 110 to a rotary motion. The rotary motion indicator handle 104 has three states, with the handle 104 pointing at: 3 o'clock (FIG. 5) in which the device is locked (in key-only implementations) or latched; 4 o'clock (FIG. 1) in which the device is open, and the latches 100 are waiting for a closing action; and 6 o'clock (FIG. 3) in which the latches 100 are open. When released, the blocking device 108's biasing spring takes the handle 104 back to the 4 o'clock position. Rotating the indicator handle 104 from 3 o'clock to 6 o'clock unlatches the rotors 102 by moving the blocking devices 108 linearly away from contact with the rotors 102. When all the strikes 106 are pushed into the rotors 102, the indicator handle 104 goes to the 3 o'clock position. The spring-biased blocking device 108 prevents the indicator handle 104 from going to the 3 o'clock position until all rotors 102 are latched. These positions are for explanation purposes only, and the actual positions can vary with implementation.

While in the 3 o'clock position, the indicator handle 104 can be locked by removing a key, by rotating the key in the handle 104 and then removing it, or by activating electronic locking.

In a preferred embodiment, the locking event for the enclosure door is controlled by an access signal from an access-control unit. Examples of both keypad- and remote-controlled access-control units are described in U.S. Pat. Nos. 5,617,082 and 6,359,547 and in U.S. Published Patent Application US2003/0234719A1, which are incorporated herein by reference in their entireties.

Where a keypad lock mounted to an enclosure is used to access the motor control as described in the patents listed above, the keypad lock offers a simple user interface of keys (such as twelve access buttons) and LED lights or an LCD display to help the user enter access control commands, enter additional access codes, check the health of the battery, etc.

When an access-control unit is desired that has no point of attack, a wireless remote control device may be used. Such a wireless access device is described in U.S. Pat. No. 5,617,082. This device offers a battery-saver feature to reduce power consumption of the lock as it waits to receive an access-code transmission. Two examples of wireless media used for this device are radio frequency and infrared. The battery-saver feature can be implemented in a number of ways: (a) full-time wherein batteries are used to power the lock; (b) not at all wherein the power to the lock is a DC power source; (c) a combination of these two modes, wherein the power-saver mode is used when it is not expected that the lock will be immediately accessed or re-locked, and wherein the full-power mode is used when it is expected that the lock may be immediately accessed or re-locked. A less desirable aspect of the battery-saver feature is a time-delayed reaction to a lock or unlock access input. The dual mode takes advantage of the power-saver during long time periods when the lock most likely is not being locked or unlocked and takes advantage of the full-power mode to react quickly to a lock or unlock access-control signal.

Wireless access-control devices may take many forms, such as a remote transmitter with a single access-code transmit button. When this single transmitter button is pressed, the complete access code is transmitted to the access-control receiver, as described in U.S. Published Patent Application US2003/0234719A1. Alternately, the wireless device reads biometric input such as a fingerprint to replace a single button as the user interface.

The remote unit can also include several keypad buttons (labeled, for example, “0” through “9”) to allow a user to enter input combinations to make up an access code. As each button is pressed, an individual, unique code representing that button is transmitted to the access-control unit. The order and combination of the codes received from the remote make up the access code for the enclosure. An example of such a device is the universal remote-control unit for a television or other consumer device.

In the example given above of a universal remote-control unit, problems exist with annunciation and with user-friendly operation of the lock. For example, the universal remote typically contains only an LED light indicating that a button was pressed and that a code was transmitted, but there is no confirmation that a particular code was received by the access-control unit. Embodiments of the present invention offer two solutions to these problems.

As a first solution, the access-control unit contains an annunciation device such as LED lights, an LCD display, or an audio annunciator to provide feedback for the user as to exactly how many key presses are received by the remote transmitter. Note that these annunciations do not give any positive or negative feedback as to whether the code received was valid or invalid, only that it was received. It also attempts to annunciate the order in which each code is received. For example, if the expected code contains five digits, then the annunciator may attempt to either light or un-light one LED for each code received, providing both feedback that the code was received and what receiving sequence this code was in as it was received. Typically, this annunciator is located such that it can be viewed from just in front of the door (say, up to ten feet back from the door). Other messages may also be displayed such as a confirmation that the complete correct code was received, that an incorrect complete code was received, that the battery is low, that an incorrect button was pressed, or that the mechanism should be unlocking.

As a second solution, the access-control unit can contain a transmission system (typically using the same transmission medium as used by the remote unit), and the remote transmission unit can contain a wireless receiver system to receive the annunciation messages from the access-control unit. The same annunciation components can be used at the remote unit. Thus, the user transmits a code via the control unit; if received, the access-control transmits a confirmation back to the remote unit; and the remote unit displays an annunciation message to the user that the code was received. Other messages may be displayed just like the ones mentioned above.

The lock system can be power either by a battery source or by an AC or DC power source. If batteries are used, then it is assumed that they are mounted inside the enclosure and are not accessible while the door is locked. The batteries are monitored for their health, and a measure of that health is announced to the user as the enclosure is accessed or locked. The batteries are usually non-rechargeable alkalines, although rechargeable types are possible.

In the event that the batteries are too low to operate the unit, the preferred embodiment has a power input port that accepts a back-up power source to power the lock thus allowing the lock mechanism to unlock once a correct access code is received. This port does not provide a hotwire to over-ride the access-control system of the lock. One such battery-back-up unit is described in U.S. Provisional Patent Application 60/523,505. In some cases, a simple nine-volt battery can be used.

In some embodiments, the clamping system consists of a base plate with a grooved steel wire shaped like a letter “L.” The “L”-shape has two grooved legs. These two legs extend through the base plate. The legs are allowed to move up and down to accommodate various types of rack bars, but can be locked from moving up and down by two clamp jaws that are shaped to have a geometry matching that of the wire grooves. The jaws have alternately positioned areas that have no grooves. When positioned by the locking handle 104, these areas allow the wire to move freely.

This clamping is further improved by having at least one angle ramp or cam surface that lifts the wire upward after the motion has caused the jaws to clamp on the wire and after the handle 104 moves towards the lock position.

A safety catch has two functions. It first serves to prevent the car-top box from lifting off in the event that the user does not clamp the box. Second, it holds the clamp handle down.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Therefore, the invention as described herein contemplates all such embodiments as may come within the scope of the following claim and equivalents thereof.

We claim:

1. A rotor-latch system, the system comprising:
a housing;
a rotor pivot shaft supported by the housing;
a rotor attached to the rotor pivot shaft, the rotor rotatable about an axis of the rotor pivot shaft; and
a strike adapted to engage with the rotor and to disengage from the rotor;
wherein when the strike is engaged with the rotor, the strike and rotor are adapted to serve as a hinge.
